(19) United States
(12) Patent Application Publication
(10) Pub. No.: US 2006/0200503 A1
(43) Pub. Date: Sep. 7, 2006

(54) Modifying back-end web server documents at an intermediary server using directives

(75) Inventors: Ferenc Dosa, Helsinki (FI); Johan Wikman, Helsinki (FI)

Correspondence Address: Hollingsworth & Funk, LLC;Suite 125, 8009 34th Avenue South, Minneapolis, MN, 55425, US

(73) Assignee: Nokia Corporation

(21) Appl. No.: 11/071,772

(22) Filed: Mar. 3, 2005

(51) Int. Cl. G06F 17/30

(52) U.S. Cl. 707/203

(57) ABSTRACT

Network services are provided by a network coupled back-end server that is accessed by an intermediary server such as a reverse proxy server. A service request is received at the back-end server via the intermediary server. The back-end server forms a first document in response to the service request. The first document contains a data generation directive targeted for the intermediary server. The first document is sent to the intermediary server. Additional data is generated at the intermediary server using the data generation directive and a second document is formed using the first document and the additional data. The second document is then sent from the intermediary server to an originator of the service request.

### FIELD OF THE INVENTION

This invention relates in general to data processing networks, and more particularly to processing network service requests at a backend server.

### BACKGROUND OF THE INVENTION

Mobile communications devices such as cell phones are gaining wide acceptance. The popularity of these devices is due their portability as well as the advanced features being added to such devices. Modern cell phones and related devices offer an ever-growing list of digital capabilities. For example, many phones may be equipped with software that allows the devices to provide network services for particular users.

One class of network services, commonly referred to as Web services, may be increasingly served from mobile devices. Web services generally refer to providing text and graphical documents using the Hypertext Transfer Protocol (HTTP). The World Wide Web, which provides an enormous amount of network-accessible information, utilizes a combination of HTTP and Internet protocols. The ubiquity of the Internet and the adoption of Web standards allows Web content to be reliably accessed nearly anywhere in the world.

Web servers are often viewed as single-purpose computers configured to handle high amounts of HTTP traffic. However, any computer can provide Web services, and these services need not consume significant processor or network bandwidth as long as access to the services is limited to a small amount of traffic. For example, an old computer that is too slow to be effective for desktop use can still be used as a Web server for a home or small office intranet. Similarly, a mobile device such as a cellular phone can act as a Web server for limited purposes, such as sharing photos, Web logs (“blogs”), or other information with a select group of individuals.

Mobile devices may inherently contain other useful data besides user-produced content. By their very nature, mobile devices may be used in any geographic location where a compatible network exists. Therefore, the environment surrounding the mobile device may provide valuable information so long as the device has a way to sense and quantify that information. For example, devices may be able to detect proximate network users, information about the currently coupled network, location information, sensor information, device information, and other types of context data.

This context data may be usefully incorporated into network services provided by a device. For example, a GPS unit included in a mobile phone may be enabled to show the location of the user to anyone who accesses that user's mobile Web page. However, the GPS unit may only provide geolocation data in the form of latitude and longitude (lat/lon). For people who might be accessing a Web page that shows someone's location, an address or map of the location is much more useful than a lat/lon value. Before forming the Web page, the mobile device could query an externally accessible database, determine an address and/or produce a map based on current latitude and longitude. The results of this query could be placed into the Web page instead of the lat/lon value.

The problem with using the mobile device to query the external database is that it slows response time of the device. The device is typically running on a low-bandwidth, high latency network connection. Therefore each separate network transaction may be expensive, both in terms of time (e.g., responsiveness) and money (e.g., where charges accrue based on bandwidth usage). These limitations may limit the usefulness of the device under such circumstances.

Therefore, improvements are needed that will allow mobile devices take advantage of external sources of data when responding to Web service requests or requests for any other type of network service provided on the device. Such improvements should account for lower network and processor bandwidth available to such devices.

### SUMMARY OF THE INVENTION

The present disclosure relates to providing data lookup services for a back-end server using an intermediary server. In accordance with one embodiment of the invention, a method involves receiving a service request at a back-end server via an intermediary server. The back-end server forms a first document in response to the service request. The first document contains a data generation directive targeted for the intermediary server. The first document is sent to the intermediary server. Additional data is generated at the intermediary server using the data generation directive and a second document is formed using the first document and the additional data. The second document is then sent from the intermediary server to an originator of the service request.

In more particular embodiments, the method further involves, before receiving the service request at the back-end server, modifying the service request at the intermediary server so that the service request includes a descriptor of data generation services available via the intermediary server. The descriptor may include an application-layer header entry and/or an HTTP header entry. In one arrangement, forming the first document at the back-end server comprises forming the first document to include a placeholder that is associated with the data generation directive. The placeholder indicates a location in the second document to place the additional data obtained using the data generation directive.

In other more particular embodiments, the method may involve forming the second document by modifying the first document with the additional data, and/or replacing the first document with the second document. Generating the additional data may involve forming the additional data based on a database lookup. In one arrangement, forming the first document at the back-end server involves forming the first document containing context data that is associated with the back-end server. The context data is provided as a variable for use with the database lookup. The context data may include any combination of sensor data, geolocation data, local network data, and user data. The intermediary server may include a reverse proxy server.

In another embodiment of the invention, a data-processing arrangement includes a network interface capable of receiving data via a network and a processor coupled to the network interface. A memory is coupled to the processor. The memory contains instructions that cause the processor to receive a service request via a reverse proxy server coupled to the network. In response to the service request, the processor forms a document that includes a data generation directive usable by the reverse proxy server for forming a second document based on the document. The processor sends the document to the reverse proxy server via the network to initiate formation of the second document. The second document is targeted for an originator of the service request.

In another embodiment of the invention, a server includes a network interface capable of receiving data via one or more networks and a processor coupled to the network interface. A memory is coupled to the processor. The memory contains instructions that cause the processor to forward a service request to a back-end server via the network interface. In response to the service request, the processor receives via the network interface a first document from the back-end server that includes a data generation directive. The processor forms a second document based on the first document and the data generation directive, and sends the second document to an originator of the service request via the network interface.

In another embodiment of the invention, a processor-readable medium has instructions stored thereon which are executable by a data processing arrangement capable of being coupled to a network. The instructions are executable by the data processing arrangement for receiving a service request via a reverse proxy server coupled to the network. In response to the service request, a document is formed that includes a data generation directive usable by the reverse proxy server for forming a second document based on the document. The document is sent to the reverse proxy server via the network to initiate formation of the second document. The second document is targeted for an originator of the service request.

In another embodiment of the invention, a processor-readable medium has instructions stored thereon which are executable by a data processing arrangement capable of being coupled to a network. The instructions are executable by the data processing arrangement for forwarding a service request to a back-end server via the network interface. In response to the service request, a first document is received from the back-end server via the network interface. The first document includes a data generation directive. The data processing arrangement forms a second document based on the first document and the data generation directive, and sends the second document to an originator of the service request via the network interface.

In another embodiment of the invention, a system includes: means for receiving a service request communicated via an intermediary server coupled to the network; means for forming a first document in response to the service request, the first document containing a data generation directive targeted for the intermediary server; means for sending the first document to the intermediary server; means for generating additional data using the data generation directive; means for forming a second document based on the first document and the additional data; and means for sending the second document to an originator of the service request.

These and various other advantages and features of novelty which characterize the invention are pointed out with particularity in the claims annexed hereto and form a part hereof. However, for a better understanding of the invention, its advantages, and the objects obtained by its use, reference should be made to the drawings which form a further part hereof, and to accompanying descriptive matter, in which there are illustrated and described specific examples of a system, apparatus, and method in accordance with the invention.

### BRIEF DESCRIPTION OF THE DRAWINGS

The invention is described in connection with the embodiments illustrated in the following diagrams.

FIG. 1 is a block diagram illustrating a network environment in which various embodiments of the invention may be practiced;

FIG. 2 is a block diagram illustrating various types of data services that may be utilized according to embodiments of the present invention;

FIG. 3 is a block diagram illustrating a message sequence for generating dynamic content via a reverse proxy according to embodiments of the present invention;

FIG. 4 is a block diagram illustrating a specific use of dynamic data generation by a reverse proxy server according to embodiments of the present invention;

FIG. 5 is a block diagram shows a representative computing implementation of a mobile back-end server capable of carrying out operations in accordance with embodiments of the present invention;

FIG. 6 is a block diagram showing a representative computing implementation of a reverse proxy server capable of carrying out operations in accordance with embodiments of the present invention; and

FIG. 7 is a flowchart illustrating a procedure for performing data generation on behalf of a back-end server according to embodiments of the present invention.

### DETAILED DESCRIPTION OF THE INVENTION

In the following description of various exemplary embodiments, reference is made to the accompanying drawings which form a part hereof, and in which is shown by way of illustration various embodiments in which the invention may be practiced. It is to be understood that other embodiments may be utilized, as structural and operational changes may be made without departing from the scope of the present invention.

Generally, the present disclosure is directed to a system for providing network services for devices that are located behind an intermediary network element such as a reverse proxy server. Generally, proxy servers are network elements that act on behalf of other servers. A reverse proxy server appears to clients as if it is the target, or back-end, server. A reverse proxy may allow hiding the back-end server from the client for security purposes. A reverse proxy provides other advantages, such as providing secure transactions that may not be supported by the back-end server, load balancing between multiple back-end servers, and reducing load on back-end servers by serving certain static pages of the back-end servers from a cache. Reverse proxy servers may include many different configurations and be implemented on a wide variety of devices. As used herein, the term “reverse proxy server” may refer to any intermediary network element that receives network service requests on behalf of another server.

In various embodiments of the invention, a reverse proxy server is configured to dynamically obtain data used to modify or replace documents that are served by the back-end servers. The back-end server and reverse proxy server use agreed-upon mechanisms for indicating what data is to be generated at the reverse proxy and how to use this data to form the resulting documents. The reverse proxy may identify, obtain, and format data using any combination of database accesses, pattern matching, character transformations, method invocations, and the like. Using the reverse proxy in this way frees the back-end server from having to perform such tasks.

It will be appreciated that the back-end server may be able to perform database lookup and insertion actions on its own. This functionality may be provided, for example, using Server-Side Includes (SSI). A Web server that supports SSI (e.g., the mod_include module for the Apache Web server) provides a handler that processes static Hypertext markup Language (HTML) documents before they are sent to the requesting browser. The processing is controlled by specially formatted comments in the documents, referred to as elements. These elements allow insertion of dynamic data, such as output from programs or database lookups, to be inserted into the returned HTML files.

Those skilled in the art will appreciate that SSI is only way that Web applications can perform dynamic data generation in order to prepare response documents. For example, with the Apache Web server there are many possible ways of dynamically forming documents, including mod_cgi, mod_python, and mod_perl. Alternatively, developers can write custom Apache modules to do database lookups and queries in order to build response documents at a back-end server. There are other also other Web server implementations, such as Microsoft Internet Information Services (IIS), that provide similar capabilities. In other applications, Java Server Page and Java Servlets technologies allow Web application developers to perform database lookups using Java APIs. There are also numerous servlet container implementations (e.g. Tomcat) that provide a framework to implement dynamic generation of documents for Web applications.

A Web application that queries remotely-located databases via low bandwidth connections may see performance degradation due to transaction roundtrip times. A mobile back-end server may have to 1) receive a service request, 2) query a database to service part of the request, 3) receive a response from the database that is used to form the response document, and 4) then send out the response document. Because mobile devices have limited network and processing bandwidth, it benefits system performance greatly if steps 2) and 3) can be taken over by the reverse-proxy server. Although this concept will work in any network system, it is particularly useful networks that have many low bandwidth servers (e.g., mobile devices) running behind a relatively speedier reverse proxy service.

There are a number of ways to have the reverse proxy server take over production of dynamic data. In one arrangement, the reverse proxy server and back-end server may have a pre-determined list of operations that are performed on every single document that is processed by the reverse proxy server. Documents may include one or more tokens that indicate the data to be inserted, and the reverse proxy searches each document for these tokens. The problem with this “brute force” arrangement is that it does not scale well. Many of the pages provided by the back-end servers will not require this insertion service. This method is also inflexible, in that it may be difficult to update the tokens for new types of content without introducing undesired side effects on old types of content. Finally, such an arrangement may not permit turning off the insertion features, should a page be requested with the tokens kept intact.

An alternative to a brute-force approach to dynamic data production/generation is to include content editor commands/directives that can be automatically constructed on the back-end server side and be programmatically interpreted on the reverse proxy server. Such commands, on the one hand, would select the operations that should be invoked to edit the content currently being handled, and on the other hand may provide additional arguments (if any) for the operation of those content editors to use. The applicability of these content editors may very greatly, from general-purpose stream editors that can be invoked with general stream-editing commands (e.g. similar to the Unix sed tool) to more fine-tuned and less application-specific content-editors.

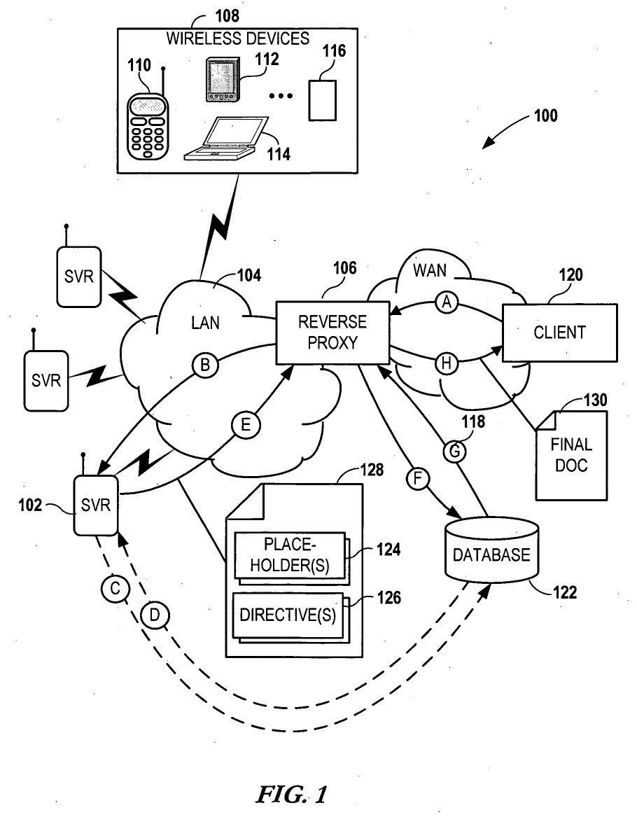

Referring now to FIG. 1, a network environment 100 is illustrated in which various embodiments of the invention may be practiced. Generally, the invention involves at least one server device 102 that is coupled via a reverse proxy server 106. The server 102 and reverse proxy server 106 may be coupled by any data transfer system known in the art, such as a local area network (LAN) 104. The LAN 104 may include a standard packet-switched data network using wired or wireless data transfer technology. Other data transfer systems may be used in place of or in addition to the LAN 104. For example, the server 102 and reverse proxy server 106 may be coupled by a cellular data transfer network, a WAN, a direct wireless connection, etc. The server 102 may be any network-capable data processing apparatus. For example, server functionality may be included on wireless devices 108.

The wireless devices 108 may include mobile phones 110, personal digital assistants (PDAs) 112, laptop/notebook computers 114, or any similar device as represented by generic device 116. Generally, the wireless devices 108 are capable of performing data exchanges through the use of wave transmissions (e.g., light and radio waves). The wireless devices 108 may also include wired interfaces, such as Ethernet, Universal Serial Bus (USB), etc. The present invention is applicable regardless of the type of processing device or means of network communications used by the server devices 102, 108.

The reverse proxy 106 is typically configured to determine the destination of application-level messages (both incoming and outgoing) handled by back-end servers 102, 108. The reverse proxy server 106 acts as a proxy for selected services that are offered via the LAN 104. Because the reverse proxy 106 may be associated with particular application-level protocols (e.g., HTTP, FTP, etc.), the reverse proxy 106 may only need to handle a subset of traffic destined for a back-end server 102, 108.

The reverse proxy server 106 may be coupled to receive network requests via both the LAN 104 and via an external, wide-area network (WAN) 118. A client device 120 coupled to the WAN 1.18 accesses the server devices 102, 108 via the reverse proxy server 106. In the illustrated, arrangement, the WAN 118 and LAN 104 may be separated by some access control device such as a firewall/router (not shown). It will be appreciated that the reverse proxy server 106 may operate in a non-firewalled environment, such as where there is no separation between the local network 104 and the client device 120. For example, the client 120 may operate within the local network 104, yet still access the server 102 via the reverse proxy server 106.

It will be appreciated that in some configurations, the reverse proxy server 106 may act as a reverse proxy only from the client's point of view. For example, if the client 120 is a Web browser utilizing HTTP, the protocol between the back-end server 102, 108 and the reverse proxy 106 may not be HTTP, but may be a different protocol that can convey HTTP messages. In such a situation, the reverse proxy server 106 still acts as a reverse HTTP proxy as far as the client 120 is concerned.

The reverse proxy server 106 may be provided as a stand-alone device, or the functions of the reverse proxy server 106 may be included with other network hardware such as firewalls, routers, etc. The reverse proxy server 106 listens for incoming requests and uses predetermined associations between clients and back-end servers 102, 108 to forward the request to the correct back-end server. For example, the reverse proxy server 106 may listen for an incoming HTTP connection as illustrated by request path A. Data contained in the HTTP header (e.g., the Host entry) may be used to send the request to the targeted back-end server 102 as illustrated by request path B.

The server device 102 typically fulfills the HTTP request by accessing stored data such as a static HTML file. Oftentimes, however, the server 102 may require dynamic data that is accessed via an external data source, such as a database 122, to properly fulfill the request. The database 122 may include centrally accessible data that is continually updated by a number of sources. Besides providing up-to-date, dynamic content, the database 122 may also be used where there is a large volume of data that is impractical to store on the server 102. Therefore, the server 102 may access the database 122 as shown in request path C and receive a response using response path D. Thereafter, the server 102 may provide the requested document to the client 120 via the proxy server 106 as shown in response paths E and H.

It will be appreciated that, because the server 102 operates in a low bandwidth environment, that any database accesses as shown in paths C and D may be expensive, both in terms of processing times and in terms of network usage charges. However, the reverse proxy server 106 generally operates in a fixed environment, and therefore typically has greater processing power and access to cheaper, high-bandwidth networks. Therefore, instead of the server device 102 accessing the database 122 to service the illustrated transaction, the database access are performed by the reverse proxy server 106.

According to one embodiment of the invention, the network service request (an HTTP request in this example) is initiated via requests paths A and B as described above. However, instead of the server 102 performing database accesses represented by paths C and D, the server inserts placeholders 124 and/or directives 126 in a document 128 that is sent for further processing to the reverse proxy server 106. The reverse proxy server 106 may utilize the directives 126 to perform a database lookup as represented by respective request and response paths F and G. The results of the database lookup are used by the reverse proxy server 106 to form a final document 130 that is sent to the client as represented by path H. Forming the final document 130 may involve placing the results of any database lookups in locations of the original document 128 as indicated by the placeholder(s) 124. In other arrangements, the final document 130 may entirely replace the original document 128.

Although the database 122 may be a standard relational database, those skilled in the art will appreciate that the database 122 may be any manner of data service that allow query-based data retrieval. For example, the database 122 may exist a Web service utilizing HTTP-based remote procedure calls (RPC), such as the Simple Object Access Protocol (SOAP) and Universal Description, Discovery and Integration (UDDI) specification. In other arrangements, the database lookup may involve accessing data stored locally on the reverse proxy server 106 (e.g., a flat file), or otherwise locally accessible by the reverse proxy server 106 (e.g., network attached storage).

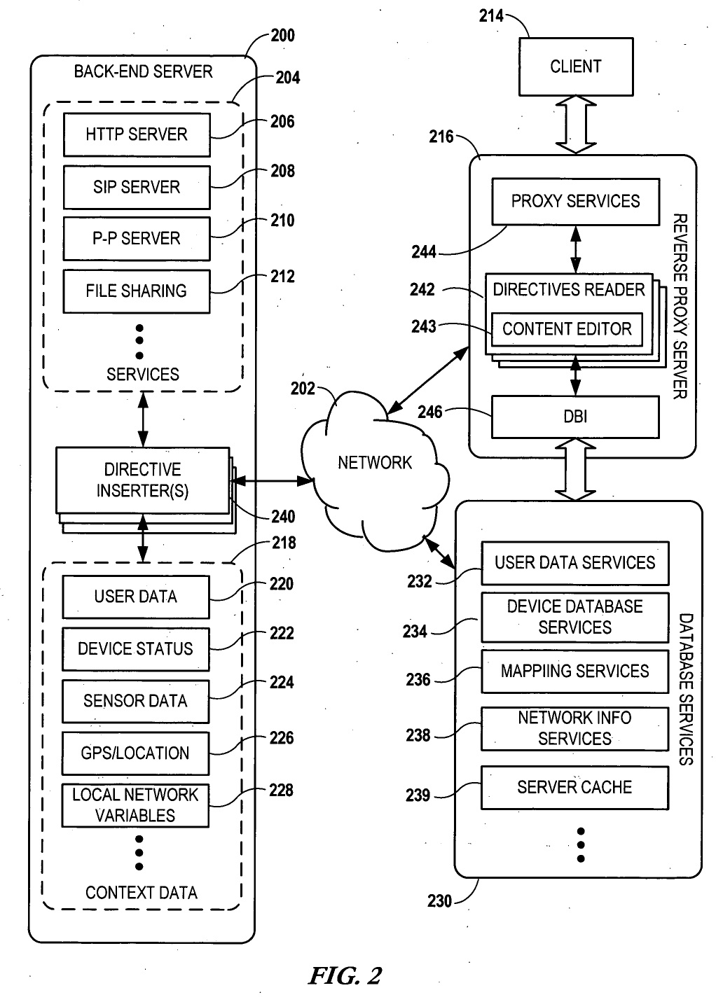

In reference now to FIG. 2, a block diagram illustrates various types of data services that may be utilized according to embodiments of the present invention. In FIG. 2, a back-end server 200 is coupled to a network 202. The server 200 may include any type or combination of data processing arrangements. The server is enabled to provide one or more network accessible services 204. For example, the services 204 may include any combination of an HTTP server 206, Session Initiation Protocol (SIP) server 208, peer-to-peer networking server 210, file sharing server 212, etc.

The services 204 of the server 200 may provide documents or other data to one or more client computers 214 via a reverse proxy server 216. The documents provided by the services 204 may include some sort of context data 218 accessible by the server 200. Generally, context data 218 may be any form of data that is uniquely visible or accessible to the server 200. For example, the context data 218 may include user data 220 (e.g., identity data, presence data), device status/capabilities data 222 (e.g., battery levels, modes, settings, terminal capabilities, terminal applications hosted by the backend server), sensor data 224 (e.g., temperature, humidity, motion detectors), Global Positioning Satellite (GPS) data 226, local network variable data 228, and the like.

When the network services 204 provide content to the client 214, the services 204 may include context data 218 within that content. In many cases, such as when inserting a user's email address, the data can be included as-is. However, in some cases the context data may require some translation in order to be useful. For example, the GPS data 226 may be provided in the form of a latitude and longitude. However, when the location is presented to the client 214 provided by a network service 204, this location data may be more effectively presented in other forms, such as by using a street address or by presenting a graphical map.

In order to perform data transformations, network entities may access a database service 230 via the network 202 (or other communication means). Generally, the database service 230 provides a data in response to a query. Typically, the queries involve providing one or more keys used to identify the relevant data. The query may also include the format desired of the return data. In the example of GPS data 226, the key might be a latitude/longitude value, and the return value may be one or both of a street address and a Uniform resource Locator (URL) pointing to a map image. Database services 230 may include user data services 232 (e.g., remotely stored user data indexed by user ID), device data services 234 (e.g., device data indexed by machine identifiers), mapping services 236, network services 238 (e.g., domain name services), etc.

The database service 230 may also contain data that originated at the back-end server 200. For example, many documents that originate from the back-end server 200 may contain redundant information such as navigation toolbars, Javascript functions, and the like. The back-end server 200 may be able to flag portions of documents for storage in a server cache 239 using a unique identifier. This data can be later retrieved to fulfill future requests from the server 200. When the redundant data is required to fulfill a subsequent service request, the back-end server 200 can insert a placeholder for the data and execute a lookup directive to the server cache 239 using the unique identifier.

In the illustrated arrangement, the server 200 includes one or more directive inserter modules 240 used to place dynamic content into documents based on directives and/or placeholders placed in the documents by the server 200. The directives may be read by a directives reader 242 on the reverse proxy server 216. The reverse proxy server 216 uses the directives to retrieve and insert dynamic content into documents or even to generate new documents after the documents are received from the server 200, but before the documents are passed on to the client 214 via a proxy interface 244. The directives reader 242 generally has the ability to read directives from the incoming documents, parse the directives, and access the database 230 (or other data source) via a database interface 246. The directives reader 242 may also include the ability to retrieve results via the database interface 246, and use the results to form the final document that is sent to the client via the reverse proxy interface 244.

Generally, the proxy server 216 may support many different types of directives, and may have a directives reader module 242 for each compatible directive. Each directives reader module 242 may access one or more content editing services 243 to fulfill the directive. For example, the directives may be inserted in the form of a series of stream editor commands similar to the Unix sed tool. The directives reader 242 may have an interpreter for such general stream editing commands and invoke content editor 243 to perform transformations similar to the ones sed is capable of in Unix-like command environments.

Generally, a directives reader 242 that uses content editors 243 to process directives requires the directives inserter 240 to form compatible directives at the back-end server 200. The directives reader 242 and directives inserter 240 may have to ability to use a wide variety of programmatic constructs to control dynamic data generation at the reverse proxy server 216. For example, these modules 240, 242 may use any combination of shell scripting languages (e.g., sh, csh, tcsh, zsh, bsh, bash, etc.), Javascript, extensible Markup Language (XML), macros, etc. The modules 240, 242 may require a mechanism to communicate supported methods of dynamic insertion. This communication may be achieved, for example, by inserting a new entry in HTTP-request headers at the reverse proxy server 216. For example, an entry such as “Ned-Proxy: yes” could be used for reverse proxy servers 216 that support content editor commands. The header could contain other information about the directives inserter and reader 240,242, such as version number, encoding of characters, etc.

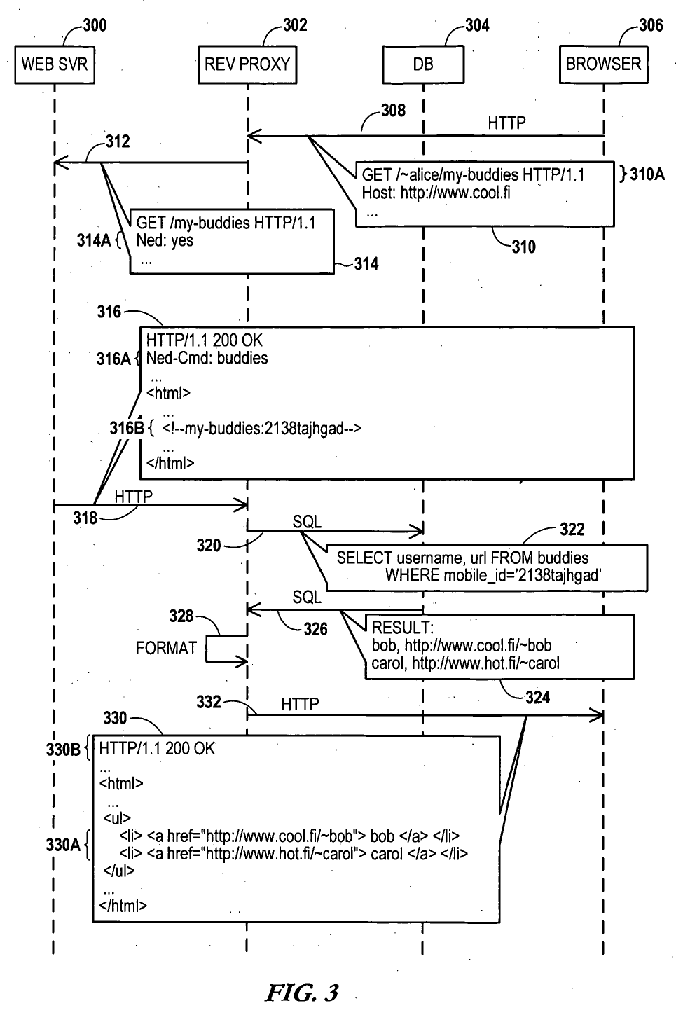

In reference now to FIG. 3, an example message sequence illustrates inserting dynamic content via a reverse proxy according to embodiments of the present invention. In the illustrated example, a back-end mobile Web server 300 provides HTTP services for requests received via a reverse proxy server 302. The Web server 300 may have a Uniform Resource Identifier (URI) such as “/my-buddies” that, when accessed, produces a Web page with a link to other mobile Web servers that are in the buddies list of Web server's owner.

The reverse proxy server 302 has access to a database 304, which may include any special or general-purpose data lookup service. The database 304 includes a buddies list that may be maintained the user of the Web server device 300. In this way, for example, mobile users can go to a centralized location to configure permissions for access to personal Web pages, and thereby limit access to a select group of users, i.e., the “buddies.” The centralized location for this list of buddies is the database 304. The database 304 may be located on the same machine as the reverse proxy server 302, or have a relatively fast connection to the reverse proxy 302.

The message exchanges begin when a browser 306 performs an HTTP request 308. In this example, the request includes the GET method, as indicated by line 310A in message header 310. The reverse proxy server 302 receives the request 308 and inserts an entry 314A in the header 314 before forwarding 312 the message to the server 300. The “Ned: yes” header entry 314A may be used to inform the Web server 300 about capabilities of the reverse proxy 302 to insert dynamic content into Web pages. The header 314 may contain multiple entries 314A describing many capabilities of the reverse proxy server 302, so that the Web server 300 may choose from alternate methods of directing the reverse proxy 302 to insert content.

After receiving the forwarded request 312, the Web server 300 provides an HTML document 316 in response 318. The document 316 will eventually contain a hyperlinked list of “my-buddies” that is located on the database 304. Instead of the Web server 300 having to query the database 304, the Web server 300 requests that the reverse proxy server 302 query the database using the stream editing function advertised by the reverse proxy server 302. The query is included in a modification directive placed in the response header at line 316A. The reverse proxy server 302 uses a content (HTML stream) editor (called “Ned” in this example) and based on this directive 316A will insert the buddies list into the document 316 on behalf of the Web server 300. The text following the “Ned-Cmd:” portion of the header entry 316A includes a predefined command that directs the reverse proxy server 302 to make a replacement. The string “Ned-Cmd: buddies” assumes that the reverse proxy server 302 has a content editor “buddies” installed that replaces all occurrences of sequences like “<!--my-buddies:2138tajhgad-->” in the placeholder 316B with the HTML formatted list of result of a query made to figure out the buddies of a user identified by “2138tajhgad” In this example, the string “2138tajhgad” is the user ID of the Web server's owner.

When the reverse proxy server 302 receives the response 318, the proxy server performs the replacement indicated by the header directive 316A. In this example, a database lookup 320 is performed using a Structured Query Language (SQL) query 322. The SQL query results in a response text 324 being sent 326 to the reverse proxy server 302. The reverse proxy server 302 uses the result of the query to insert a HTML formatted portion with the list of buddies as replacement text for the special purpose HTML comment used as a substitution placeholder 316B (“<!--my-buddies: . . . -->”).

After properly formatting the database response 324 and replacing the placeholder 316B in the original document, the reverse proxy server 302 forms the resulting HTML response document 330 and sends 332 the document to the browser 306. The portion of the message that previously had the placeholder text 316B now includes address lines 330A, which is HTML formatted user data that was derived from the database response text 324. Note that the header portion 330B of the response document 330 no longer includes the “Ned-Cmd:” as in the original response message 316. This header entry is not needed by the browser 306, therefore it may be advisable to remove the entry before sending the resulting document 330 to the browser 306.

The exchanges illustrated in FIG. 3 are merely representative of utilizing a reverse proxy server to dynamically look up, format, and insert data into documents or other data provided by a back-end server. The directives used to cause text insertion may be applied to multiple placeholders within the document. The directives may also be configured to accept data (e.g., arguments) that set content editing options and/or help identify the placeholders. For example, the “buddies” command may be configured to accept an argument such as “<!--my-buddies: (.*)-->”, which is a regular expression that can be used by the content editor (e.g. similar to sed) to find the placeholder 316B in this example. The parenthesis in this expression act as a backreference operator that can be used to communicate to the content editor the location of the context data (e.g., the username) within the placeholder. By using directives that accept arguments, the Web server 300 may have greater flexibility in forming placeholders and in controlling the appearance of the final document.

In other configurations, multiple directives, each affecting one or more different placeholders, may be included in one or more header lines of the response messages. Multiple directives may be applied sequentially, and may operate independently or dependently (e.g., the result of one content editor used as the input to another content editor). The data used by the reverse proxy to form the resulting documents may include any combination of text, binary data, images, executable code, embedded objects, or any other data known in the art.

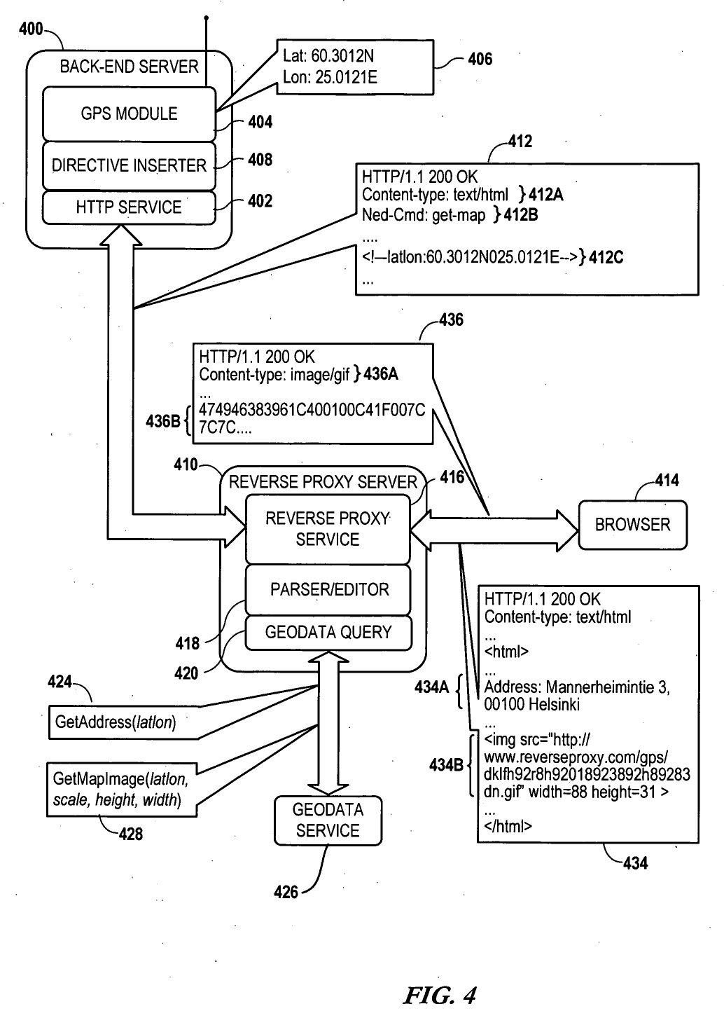

In reference now to FIG. 4, a specific use of dynamic data production by a reverse proxy server is illustrated according to embodiments of the present invention. A mobile device (or similar apparatus) is configured as a backend server 400. The back-end server 400 contains the ability to create and serve Web pages, as provided by an HTTP service module 402. The requests for Web pages originate at a browser 414 or similar entity, and the requests are received at the back-end server 400 via a reverse proxy server 410.

The back-end server 400 includes a GPS module 404 that provides geolocation data 406. A directive inserter 408 works in concert with the HTTP service 414 and the GPS module 404 to insert the geolocation data 406 into selected Web pages requested by the browser 414. In this example, the directive inserter 408 works with the reverse proxy server 410 to provide address data and/or graphical map images via a response page 412 originating from the back-end server 400. To locate the correct address and/or image, the back-end server 400 provides the geolocation data 406 in the response page 412. The reverse proxy server 410 will perform database lookups to access a graphical image file (e.g., a GIF file) and/or addresses based on the geolocation coordinates. The resulting text data and/or image file (or a URL referencing the file) may be used to modify, supplement, or replace the response document 412.

The directive inserter 408 will generally be capable of understanding the nature of the data provided so that it can effectively form a directive usable by a reverse proxy server 410 in performing queries and substituting lookup results into documents. In this example, the geolocation data 406 includes latitudes and longitudes represented as decimal degrees. The inserter 408 may form one or more placeholders 412C in the response HTML page 412 using the geolocation data 406. The placeholder 412C may include appropriate tags (e.g., comment tags) to “protect” the placeholder data from HTML rendering engines. For example, the directive inserter 408 use text such as “<!--latlon:60.3012N025.0121E-->” as a one-line placeholder for geolocation data.

The directive inserter 408 will need a way to inform the reverse proxy server 410 of how to make use of placeholders such as 412C. In this example, a directive “Ned-Cmd: get-map” 412B would cause the reverse proxy 410 to activate the content editor “get-map” for this HTML page 412. The “get-map” content editor causes the reverse proxy server 410 to perform predetermined map data modifications using the response document 412. The “get-map” content editor would search for all occurrences of sequences like <!--latlon:60.3012N025.0121E--> and use the embedded argument therein (‘60.3012N025.0121E’) to generate a graphical map.

The back-end server 400 and reverse proxy server 410 may have predetermined mechanisms for defining geolocation formats in the response message 412. For example, latitudes and longitudes may be inserted using alternate formats such as degree/minute/second (dms). The formats may be indicated by using different content editor commands in the directive header entry 412B (e.g., “get-map-latlon-decimal”), passing arguments into the content editor (e.g., “get-map(latlon_dms)”), using different placeholder comments (e.g., “<!--latlon_dms:60|18|04.3N 025|00|43.5E-->), etc.

In the illustrated example, it is assumed that the reverse proxy server 410 had previously advertised its insertion capabilities, such as by adding header entries 314A to the HTTP request as shown in FIG. 3. The HTTP header entry 412B in the response message 412 indicates to the reverse proxy server 418 that the server 400 is requesting the use of the advertised mapping service. A reverse proxy service module 416 will typically parse the header entry 412B, and pass the header data to the appropriate handler, which in this example is the NED parser/editor module 418.

The parser/editor module 418 evaluates the expression in the HTTP header 412B, and edits content of the document 412. The content editor parser/editor module 418 may edit the document 412 using data obtained via a geodata query interface 420. In this example, the coordinates contained in the placeholder 412C may be used to in data queries performed by the “get-map” function. In one configuration, the “get-map” function may send a query 424 to a geodata service 426 and obtain a street address based on a geolocation coordinate.

In another configuration, the “get-map” function may provide a graphical image file generated via a different query 428 to the geodata service 426. The parser/editing module 418 may need other data to perform the query 428, such as image size or map scale. This other data may be provided in the response document 412, and/or predetermined default values may be used.

It will be appreciated that the “get-map” function may be arranged to perform any combination of data lookups, and the result of the “get-map” function may include combinations of textual and graphical data. For example, one version of the resulting document 434 may be a modified form of the original response document 412 where the placeholder 412C is replaced with address data 434A and a URL of a map image 434B. This modified document 434 is then sent to the browser 414 in response to the request. Alternatively, the “get-map” function may be arranged to replace the original document 412 with a completely different document 436, and send the replacement document 436 to the browser 414. Note that the replacement document 436 may be of a different type than the original document, as indicated by respective content-type headers 412A and 436A. The remainder of the replacement document 436 contains the content 436B of the map, represented here in hexadecimal format.

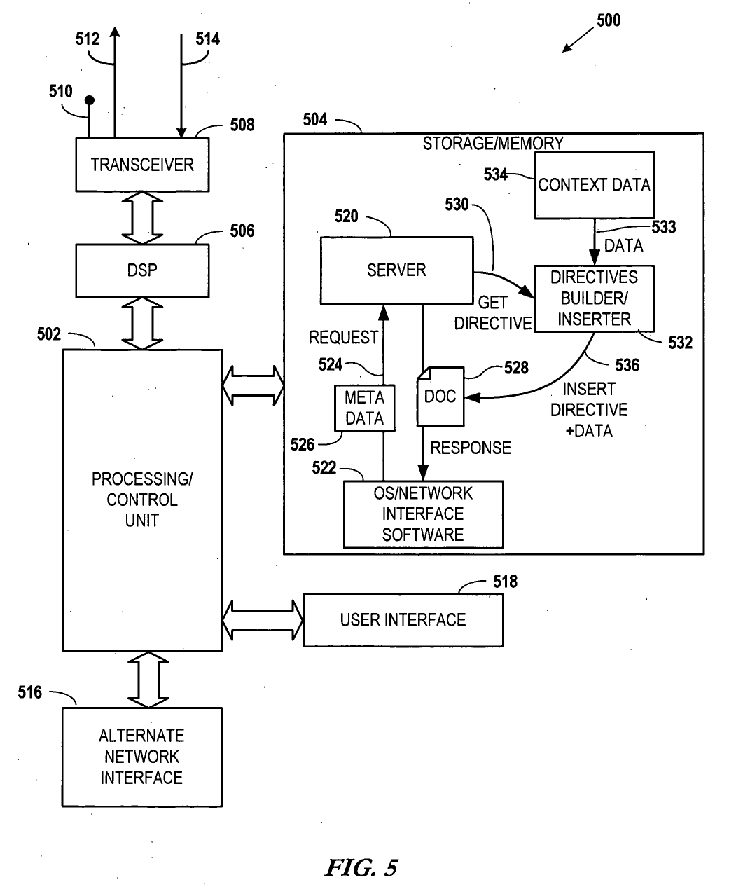

Many types of apparatus may be configured to perform roles as back-end servers. Mobile devices may increasingly take on the role of back-end servers, and would benefit from a reverse proxy server that performs data insertion. In FIG. 5, an example mobile computing arrangement 500 is illustrated that is capable of carrying out operations in accordance with embodiments of the invention. Those skilled in the art will appreciate that the exemplary mobile computing arrangement 500 is merely representative of general functions that may be associated with such mobile devices, and also that landline computing systems similarly include computing circuitry to perform such operations.

The illustrated mobile computing arrangement 500 may suitable at least for performing roles as a service provider on one or more networks. The mobile computing arrangement 500 includes a processing/control unit 502, such as a microprocessor, reduced instruction set computer (RISC), or other central processing module. The processing unit 502 need not be a single device, and may include one or more processors. For example, the processing unit may include a master processor and associated slave processors coupled to communicate with the master processor.

The processing unit 502 controls the basic functions of the arrangement 500. Those functions associated may be included as instructions stored in a program storage/memory 504. In one embodiment of the invention, the program modules associated with the storage/memory 504 are stored in non-volatile electrically-erasable, programmable read-only memory (EEPROM), flash read-only memory (ROM), hard-drive, etc. so that the information is not lost upon power down of the mobile terminal. The relevant software for carrying out conventional mobile terminal operations and operations in accordance with the present invention may also be transmitted to the mobile computing arrangement 500 via data signals, such as being downloaded electronically via one or more networks, such as the Internet and an intermediate wireless network(s).

The program storage/memory 504 may also include operating systems for carrying out functions and applications associated with functions on the mobile computing arrangement 500. The program storage 504 may include one or more of read-only memory (ROM), flash ROM, programmable and/or erasable ROM, random access memory (RAM), subscriber interface module (SIM), wireless interface module (WIM), smart card, hard drive, or other removable memory device.

The mobile computing arrangement 500 includes hardware and software components coupled to the processing/control unit 502 for performing network data exchanges. The mobile computing arrangement 500 may include multiple network interfaces for maintaining any combination of wired or wireless data connections. In particular, the illustrated mobile computing arrangement 500 includes wireless data transmission circuitry for performing network data exchanges.

This wireless circuitry includes a digital signal processor (DSP) 506 employed to perform a variety of functions, including analog-to-digital (A/D) conversion, digital-to-analog (D/A) conversion, speech coding/decoding, encryption/decryption, error detection and correction, bit stream translation, filtering, etc. A transceiver 508, generally coupled to an antenna 510, transmits the outgoing radio signals 512 and receives the incoming radio signals 514 associated with the wireless device.

The mobile computing arrangement 500 may also include an alternate network interface 516 coupled to the processing/control unit 502. The alternate interface 516 may include the ability to communicate on proximity networks via wired and/or wireless data transmission mediums. The alternate interface 516 may include the ability to communicate on networks using Bluetooth, 802.11 Wi-Fi, Ethernet, IRDA, and related networking technologies. The processor 502 is also coupled to user-interface 518 elements associated with the mobile terminal. The user-interface 518 of the mobile terminal may include, for example, a display such as a liquid crystal display, a keypad, speaker, microphone, etc. These and other user-interface components are coupled to the processor 502 as is known in the art. Other user-interface mechanisms may be employed, such as voice commands, switches, touch pad/screen, graphical user interface using a pointing device, trackball, joystick, or any other user interface mechanism.

The storage/memory 504 of the mobile computing arrangement 500 may include software modules for providing network services via any of the network interfaces (e.g., transceiver 508 and alternate interface 516). In particular, a server module 520 provides network services via network interface software 522. Typically, the network interface software 522 includes various protocols stacks (e.g., TCP/IP, UDP/IP) and may be provided by any combination of the user software, operating systems, drivers, and/or hardware components. The server module 520 may be any process or routine that accepts incoming service requests 524 from the network interface software 522.

The incoming request 524 may include meta-data 526 (e.g., HTTP headers) that describes data insertion capabilities of a reverse-proxy server. This meta-data 526 may include a description of a program (e.g., stream editor) that is configured to accept directives from the mobile computing arrangement 500. These directives may be used to lookup and insert data into outgoing documents 528 sent via reverse proxy server. Generally, the service module may invoke 530 a directives builder/inserter 532. The directives builder/inserter 532 may be a separate module that accesses context data 534 and uses the data 534 to form directives for insertion into the outgoing document 528.

The directives builder/inserter 532 may be configured as a generic software module that instantiates concrete functionality based on the meta-data 526 and the type of service requested 524 of the server module 520. For example, the meta-data 526 may indicate that the reverse proxy server supports sed regular expressions. The request 524 may be for a Web page that is configured to use a database lookup based on local sensor data. Therefore, the directives builder/inserter 532 would instantiate an object compatible with the directive interpreter installed on the reverse http proxy to build directives/content editor commands. The directives builder/inserter 532 would also instantiate a context data interface object configured to provide 533 context data. These two objects would work together to build the directives and placeholders and insert them 536 in the outgoing document 528. The directives may include a predetermined lookup function of the reverse proxy server that uses the local sensor data for a database access.

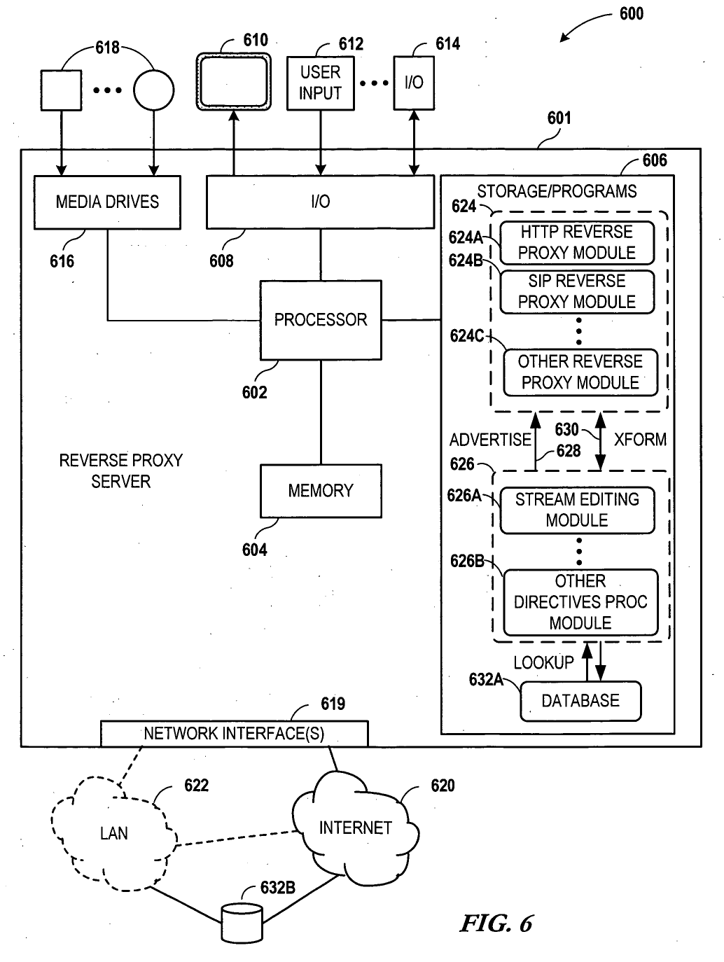

In reference now to FIG. 6, a block diagram shows a representative computing implementation of a reverse proxy server capable of carrying out operations in accordance with the invention. The example computing arrangement 600 suitable for performing the service functions of the reverse proxy server 601 includes a central processor 602, which may be coupled to memory 604 and storage 606. The processor 602 carries out a variety of standard computing functions as is known in the art, as dictated by software and/or firmware instructions. The storage 606 may represent firmware, hard-drive storage, etc. The storage 606 may also represent other types of storage media to store programs, such as programmable ROM (PROM), erasable PROM (EPROM), etc.

The processor 602 may communicate with other internal and external components through input/output (I/O) circuitry 608. The reverse proxy server 601 may therefore be coupled to a display 610, which may be any type of known display or presentation screen such as LCD displays, plasma display, cathode ray tubes (CRT), etc. A user input interface 612 is provided, including one or more user interface mechanisms such as a mouse, keyboard, microphone, touch pad, touch screen, voice-recognition system, etc. Any other I/O devices 614 may be coupled to the reverse proxy server 601 as well.

The reverse proxy server 601 may also include one or more media drive devices 616, including hard and floppy disk drives, CD-ROM drives, DVD drives, and other hardware capable of reading and/or storing information. In one embodiment, software for carrying out the data insertion operations in accordance with the present invention may be stored and distributed on CD-ROM, diskette or other form of media capable of portably storing information, as represented by media devices 618. These storage media may be inserted into, and read by, the media drive devices 616. Such software may also be transmitted to the reverse proxy server 601 via data signals, such as being downloaded electronically via one or more network interfaces 619. The reverse proxy server 601 may be coupled to other computing devices, such as the landline and/or mobile terminals, via the network interface 619. The server may be, for example, coupled to a Local-Area Network (LAN) 622 and/or may be part of a larger network configuration as in a global area network (GAN) such as the Internet 620, which allows ultimate connection to the various landline and/or mobile client devices.

In accordance with one embodiment of the invention, the storage 606, memory 604, and/or media devices 618 store the various programs and data used in connection with the present invention. In the illustrated embodiment of FIG. 6, the storage 606 is shown storing various program modules operable in connection with the processor 602. In particular, reverse proxy modules 624 may provide application specific reverse proxy services. For example, an HTTP reverse proxy module 624A provides the functionality for communicating between HTTP clients and back-end Web servers. Any number of reverse proxy modules may be provided via the reverse proxy server 601 as previously described. In the illustrated embodiment, a plurality of such service modules are provided, including a SIP reverse proxy module 624B and other reverse proxy modules 624C.

The reverse proxy modules 624 may utilize one or more directives processing modules 626. For example, a directives processing module 626A may advertise 628 its capabilities to back-end clients (e.g., by inserting application header entries into service requests) and transform 630 documents using content editor directives (commands, placeholders and arguments) provided by the back-end servers. Other programming and text transformation tools may provide similar document editing functionality, as represented by the other directive processing module 626B.

A database 632A may also be provided at the storage module 606, to store service-related information such as user preference data, network information data, and the like. The database 632A can be used by the directives processing modules 626 for purposes of transforming 630 documents. Such a database 632A may instead (or in addition) be maintained elsewhere, such as on the network as illustrated by database 632B. It should be recognized that these programs and data may be stored in memory 604, on other media 618, or accessible via one or more networks 620, 622 rather than being stored in the storage 606. The particular storage location is not relevant to the present invention.

The computing arrangements 500, 600 of FIGS. 5 and 6 are provided as representative examples of a computing environments in which the principles of the present invention may be applied. From the description provided herein, those skilled in the art will appreciate that the present invention is equally applicable in a variety of other currently known and future mobile and landline computing environments. Thus, the present invention is applicable in any known computing structure where data may be communicated via a network.

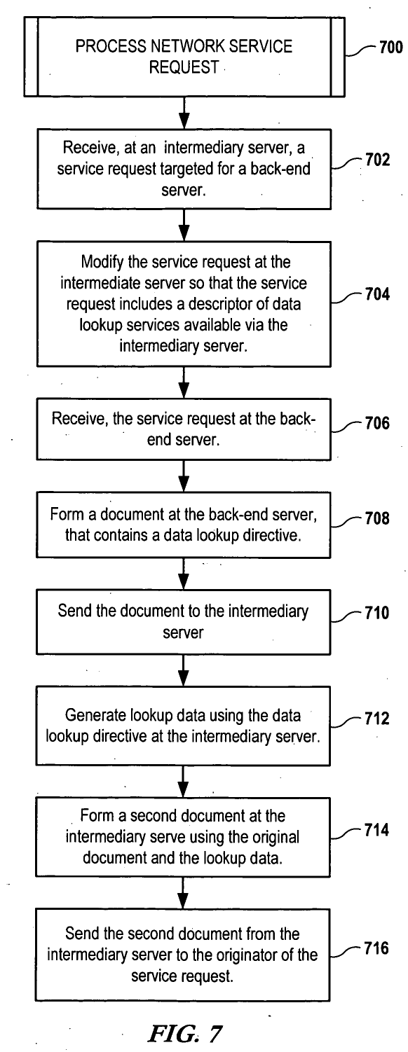

Turning now to FIG. 7, a flowchart illustrates a procedure 700 for performing data insertion on behalf of a back-end server according to embodiments of the present invention. First, an intermediary server receives (702) a service request targeted for a back-end server. This service request could be, for example, an HTTP GET received at a reverse proxy server that is targeted for a back-end Web server. The intermediary server modifies (704) the service request so that the service request includes a descriptor of data lookup services available via the intermediate server. This modification (704) may include, for example, adding HTTP headers.

After modification (704), the request is received (706) at the back-end server. The back-end server forms (708) a response document (e.g., an HTML document) that includes a data lookup directive. This directive is usable by the intermediary server for modifying the document. The directive may also include proximity data that is locally accessible by the back-end server, and can be used for data lookups by the intermediary server. The document is then sent (710) to the intermediary server.

Upon receiving the document, the intermediary server generates (712) lookup data using the data lookup directive. The intermediary server forms (714) a document using the lookup data and the original document. This may involve, for example, performing a search and replace operation of predetermined placeholders in the first document. Forming (714) the second document may also involve generating an entirely new document based on the lookup data and the original document. Finally, the second document is sent (716) to the originator of the service request.

Hardware, firmware, software or a combination thereof may be used to perform the various functions and operations described herein. Articles of manufacture encompassing code to carry out functions associated with the present invention are intended to encompass a computer program that exists permanently or temporarily on any computer-usable medium or in any transmitting medium which transmits such a program. Transmitting mediums include, but are not limited to, transmissions via wireless/radio wave communication networks, the Internet, intranets, telephone/modem-based network communication, hard-wired/cabled communication network, satellite communication, and other stationary or mobile network systems/communication links. From the description provided herein, those skilled in the art will be readily able to combine software created as described with appropriate general purpose or special purpose computer hardware to create a system, apparatus, and method in accordance with the present invention.

The foregoing description of the exemplary embodiments of the invention has been presented for the purposes of illustration and description. It is not intended to be exhaustive or to limit the invention to the precise form disclosed. Many modifications and variations are possible in light of the above teaching. It is intended that the scope of the invention be limited not with this detailed description, but rather defined by the claims appended hereto.

What is claimed is:

1. A method of providing network services from a back-end server capable of being coupled to a network, comprising:
receiving, at the back-end server, a service request communicated via an intermediary server coupled to the network;
forming a first document at the back-end server in response to the service request, the first document containing a data generation directive targeted for the intermediary server;
sending the first document to the intermediary server;
generating, at the intermediary server, additional data using the data generation directive;
forming a second document based on the first document and the additional data; and
sending the second document from the intermediary server to an originator of the service request.

2. The method of claim 1, further comprising, before receiving the service request at the back-end server, modifying the service request via the intermediary server so that the service request includes a descriptor of data generation services available via the intermediary server, and wherein the data generation directive is selected by the back-end server to be compatible with the data generation services.

3. The method of claim 2, wherein the descriptor comprises an application-layer header entry.

4. The method of claim 2, wherein the descriptor comprises an HTTP header entry.

5. The method of claim 1, wherein forming the first document at the back-end server comprises forming the first document to include a placeholder that is associated with the data generation directive, the placeholder indicating a location in the second document to place the additional data obtained using the data generation directive.

6. The method of claim 1, wherein forming the second document further comprises modifying the first document with the additional data.

7. The method of claim 1, wherein forming the second document further comprises replacing the first document with the second document.

8. The method of claim 1, wherein generating the additional data comprises forming the additional data based on a database lookup.

9. The method of claim 8, wherein forming the first document at the back-end server comprises forming the first document to include context data that is associated with the back-end server, the context data provided as a variable for use with the database lookup.

10. The method of claim 9, wherein the context data includes any combination of sensor data, geolocation data, local network data, and user data.

11. The method of claim 1, wherein the intermediary server comprises a reverse proxy server.

12. A data-processing arrangement, comprising:
a network interface capable of receiving data via a network;
a processor coupled to the network interface; and
a memory coupled to the processor, the memory containing instructions that cause the processor to,
receive a service request via a reverse proxy server coupled to the network;
in response to the service request, form a first document that includes a data generation directive usable by the reverse proxy server for forming a second document based on the first document; and
send the document to the reverse proxy server via the network to initiate formation of the second document and sending of the second document to an originator of the service request.

13. The data-processing arrangement of claim 12, wherein the service request includes a descriptor of data generation services available via the reverse proxy server, and wherein the data generation directive is selected by the data-processing arrangement to be compatible with the data generation services.

14. The data-processing arrangement of claim 13, wherein the descriptor comprises an application-layer header entry.

15. The data-processing arrangement of claim 13, wherein the descriptor comprises an HTTP header entry.

16. The data-processing arrangement of claim 12, wherein the first document further comprises a placeholder that is associated with the data generation directive, the placeholder indicating a location in the second document to place additional data obtained using the data generation directive.

17. The data-processing arrangement of claim 12, wherein the first document further comprises context data that is associated with the data-processing arrangement, the context data used in a database lookup performed at the reverse proxy server for forming the second document.

18. The data-processing arrangement of claim 17, wherein the context data includes any combination of sensor data, geolocation data, local network data, and user data.

19. A server, comprising:
a network interface capable of receiving data via one or more networks;
a processor coupled to the network interface; and
a memory coupled to the processor, the memory containing instructions that cause the processor to,
forward a service request to a back-end server via the network interface;
in response to the service request, receive via the network interface a first document from the back-end server that includes a data generation directive;
form a second document based on the first document and the data generation directive; and
send the second document to an originator of the service request via the network interface.

20. The server of claim 19, wherein the instructions further cause the processor to, before forwarding the service request, modify the service request to include a descriptor of data generation services available via the server, and wherein the data generation directive is selected by the back-end server to be compatible with the data generation services.

21. The server of claim 20, wherein the descriptor comprises an application layer header entry.

22. The server of claim 20, wherein the descriptor comprises an HTTP header entry.

23. The server of claim 19, wherein the first document further comprises a placeholder that is associated with the data generation directive, and wherein the instructions further cause the processor place additional data obtained using the data generation directive in a location in the second document indicated by the placeholder.

24. The server of claim 19, further comprising a database interface capable of accessing a database, and wherein the instructions further cause the processor to obtain additional data via the database interface in response to the data generation directive, the additional data used form the second document.

25. The server of claim 24, wherein the first document further comprises context data that is associated with the back-end server, the context data provided as a lookup variable for obtaining the additional data via the database interface.

26. The server of claim 25, wherein the context data includes any combination of sensor data, geolocation data, local network data, and user data.

27. The server of claim 19, wherein the instructions cause the processor to form the second document by modifying the first document with additional data obtained using data generation directive.

28. The server of claim 19, wherein the instructions cause the processor to form the second document by replacing the first document with the second document.

29. A processor-readable medium having instructions stored thereon which are executable by a data processing arrangement capable of being coupled to a network, the instructions executable by the data processing arrangement for performing steps comprising:
receiving a service request via a reverse proxy server coupled to the network;
in response to the service request, forming a document that includes a data generation directive usable by the reverse proxy server for forming a second document based on the document; and
sending the document to the reverse proxy server via the network to initiate formation of the second document and sending of the second document to an originator of the service request.

30. The processor-readable medium of claim 29, wherein forming the document further comprises including in the document context data that is associated with the data processing arrangement, the context data used for a database lookup performed at the reverse proxy server for forming the second document.

31. A processor-readable medium having instructions stored thereon which are executable by a data processing arrangement capable of being coupled to a network via a network interface, the instructions executable by the data processing arrangement for performing steps comprising:
forwarding a service request to a back-end server via the network interface;
in response to the service request, receiving via the network interface a first document from the back-end server, the first document including a data generation directive;
forming a second document based on the first document and the data generation directive; and
sending the second document to an originator of the service request via the network interface.

32. The processor-readable medium of claim 31, wherein the steps further comprise, before forwarding the service request, modifying the service request to include a descriptor of data generation services available via the data processing arrangement, and wherein the data generation directive is selected by the back-end server to be compatible with the data generation services.

33. The processor-readable medium of claim 31, wherein the steps further comprise obtaining additional data via a database in response to the data generation directive, the additional data used to form the second document.

34. The processor-readable medium of claim 31, forming the second document based on the first document comprises forming the second document by modifying the first document with additional data obtained using data generation directive.

35. The processor-readable medium of claim 31, forming the second document based on the first document comprises replacing the first document with the second document.

36. A system comprising:
means for receiving a service request communicated via an intermediary server coupled to the network;
means for forming a first document in response to the service request, the first document containing a data generation directive targeted for the intermediary server;
means for sending the first document to the intermediary server;
means for generating additional data using the data generation directive;
means for forming a second document based on the first document and the additional data; and
means for sending the second document to an originator of the service request.
